(19) United States
(12) Patent Application Publication
(10) Pub. No.: US 2007/0104349 A1
(43) Pub. Date: May 10, 2007

(54) Tally image generating method and device, tally image generating program, and confidential image decoding method

(75) Inventors: Emi MYODO, Fujimino-shi (JP); Shigeyuki Sakazawa, Fujimino-shi (JP); Yasuhiro Takishima, Fujimino-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KDDI CORPORATION, Tokyo (JP)

(21) Appl. No.: 11/550,078

(22) Filed: Oct. 17, 2006

(30) Foreign Application Priority Data
Oct. 17, 2005 (JP) 2005-301592

(51) Int. Cl. G06K 9/00; H04N 1/40

(52) U.S. Cl. 382/100; 358/3.03

(57) ABSTRACT

A second tally image generating means 20 that outputs a pixel value B1m,n of a second tally image B1 includes a decoding-time peripheral luminance value calculating section composed of a decoded pixel value calculating means 28 and a peripheral luminance value calculating means 29. The decoding-time peripheral luminance value calculating means 29 calculates a luminance value dm,n around a currently processed pixel. A confidential-image embedding means 26 calculates a pixel value B1m,n of a second tally image B1 by use of a temporarily determined pixel value B1^{t}m,n, a luminance value Sm,n of a confidential image S, a pixel value B0m,n of a first tally image B0 and the peripheral luminance value dm,n.

### BACKGROUND OF THE INVENTION

1. Field of the Invention

The present invention relates to a tally image generating method and a device, a tally image generating program, and a confidential-image decoding method, and particularly, to a tally image generating method and a device, a tally image generating program, and a confidential-image decoding method that can speedily generate high-quality tally images in which a continuous multitone gray-scale confidential image such as a natural image is embedded, without spending a huge calculation cost and can decode the confidential image from a tally image in a condition where the respective tally images cannot be completely or practically recognized.

2. Description of the Related Art

Conventionally, various tally image generating methods have been proposed. Tally means that, although one or a partial tally does not show confidential information, the confidential information is known by superposing a plurality of tallies. For example, as shown in FIG. 13, when tally images B0 and B3 are halftone images indicating black pixels as 0 and indicating white pixels as 1, a confidential image can be decoded by applying Boolean operation such as AND, OR, or XOR to each pixel of the tally images B0 and B1. The confidential image cannot be recognized in the tally images B0 or B1. Here, ones that allow decoding a confidential image by applying Boolean operation to each pixel of a plurality of tally images are called image electronic tally.

Image electronic tally that allow decoding a confidential image by an AND operation have a feature that a confidential image can be visually decoded without calculation by printing respective tally images on a transparent sheet and optically superposing these.

FIG. 14 and FIG. 15 are conceptual diagrams showing tally image generating methods. By the tally image generating method of FIG. 14, a confidential image S is dispersed, and the dispersed confidential image and original images A0 and A1 are inputted to first and second tally image generating means 10 and 20 (binarizing means). Tally images (halftone image) B0 and B1 are generated by embedding the dispersed confidential image into the original images A0 and A1 by the first and second tally image generating means 10 and 20, respectively. Such tally image generating methods have been described in Patent Literature 2 and Non-Patent Literature 1, 2, and 3.

By the tally image generating method of FIG. 15, first, an original image A0 is inputted to a first tally image generating means 10 so as to generate a tally image (halftone image) B0. Next, the tally image B0, a confidential image S, and an original image A1 are inputted to a second tally image generating means 20 so as to generate a tally image (halftone image) B1. Such tally image generating methods have been described in Patent Literature 1 and Non-Patent Literature 4.

It is difficult to recognize the confidential image S from each of the tally images B0 and B1 generated by the tally image generating means of FIG. 14 and FIG. 15, and it is not until superposing the tally images B0 and B1 that the confidential image S can be recognized.

Some of the tally image generating methods for generating tally images as halftone images place emphasis on expressiveness of a confidential image, and some place emphasis on tally images. The conventional tally image generating methods that places emphasis on expressiveness of a confidential image are rich in entertainment ability since tally images in which a continuous multitone confidential image such as a natural image is embedded, can be generated and the multitone gray-scale confidential image can be decoded from the tally images, however, these sacrifice halftone reproducibility of original images in the tally images and secrecy of the confidential image in the tally images.

A tally image generating method described in Non-Patent Literature 1 is based on a halftone image generating method by a density pattern method, and is categorized as a tally image generating method that places emphasis on expressiveness of a confidential image. In the tally image generating method, a tone error is distributed to a plurality of tally images in order to reproduce a confidential image tone. Although a multitone gray-scale confidential image that is high in expressiveness can be embedded, the confidential image and density of one tally image slightly stand out in the other, so that secrecy of the confidential image and tone reproducibility of original images in the tally images are sacrificed.

A tally image generating method described in Non-Patent Literature 2 is based on an exploratory halftone image generating method for determining a pixel arrangement close to an optimal calculation value by trying a pixel arrangement over and over again, and this is also categorized as a tally image generating method that places emphasis on expressiveness of a confidential image. In the tally image generating method, not only can a multitone confidential image that is high in expressiveness be embedded, but also tally images as well as the confidential image can be provided with a high quality, however, a dynamic range to express tally images is limited so that tone reproducibility of original images in the tally images is sacrificed.

However, both the tally image generating methods of Non-Patent Literature 1 and 2 are very high in entertainment ability since a multitone gray-scale confidential image can be decoded by superposing two tally images and the respective tally images cannot be recognized in the decoded image.

On the other hand, the conventional tally image generating method that places emphasis on tally images is for embedding a binary or ternary confidential image, and is limited in decoding a binary or ternary confidential image instead of sacrificing tone reproducibility of original images in the tally images. Such a tally image generating method is suitable for security-related usages such as embedding binary or ternary character images indicating a copyright notice as a confidential image.

A tally image generating method described in Patent Literature 1 is categorized as a tally image generating method that places emphasis on tally images, whereby a plurality of high-quality tally images can be generated. Moreover, the tally images can be generated relatively speedily, so that no such huge calculation cost as in the exploratory halftone image generating method is necessary.

A tally image generating method described in Patent Literature 2 is based on a halftone image generating method by a density pattern method, and tally image generating methods described in Non-Patent Literature 3 and 4 are based on a halftone image generating method by an organized dither method or an error diffusion method. These tally image generating methods are also basically for embedding a binary confidential image.

[Patent Literature 1] US Published Patent Application No. 2002/0106102

[Patent Literature 2] Japanese Published Unexamined Patent Application No. H09-252397

[Non-Patent Literature 1] M. Nakajima, and Y. Yamaguchi, “Extended visual cryptography for natural images,” Journal of WSCG Vol. 2, pp. 303-310, 2002.

[Non-Patent Literature 2] Chai Wah Wu and Gerhard R. Thompson, “Digital watermarking and steganography via overlays of halftone images,” Proceedings of SPIE, Vol. 5561, pp. 152-163, 2004.

[Non-Patent Literature 3] Kazuhiro Oka, Kineo Matsui, “Embedding Signature Information in Hard-Copy Image by organized Dither Method,” J. IEICE, Vol. J80-D-II, No. 3, pp. 820-923, 1997.

[Non-Patent Literature 4] Ming, Sun Fu; AU, O. C, “A novel method to embed watermark in different halftone images: data hiding by conjugate error diffusion (DHCED),” Multimedia and Expo, 2003. ICME '03. Proceedings. 2003 International Conference on Volume 1, 6-9 Jul. 2003 Page(s): I-609-12 Vol. 1.

The tally image generating methods described in Patent Literature 1 and 2 and Non-Patent Literature 3 and 4 are limited to the confidential image being embedded in a binary or ternary image and do not correspond to embedding a continuous multitone gray-scale confidential image. Although tally images can be generated speedily by the tally image generating methods described in Patent Literature 2 and Non-Patent Literature 3, these images are not excellent in image quality.

The tally image generating method of Non-Patent Literature 1 allows embedding a multitone gray-scale confidential image, however, this is based on a density pattern method and has a problem such that randomness in pixel arrangement of the tally images is high and image quality is poor.

The tally image generating method of Non-Patent Literature 2 allows embedding a multitone gray-scale confidential image, however, this is based on an exploratory halftone image generating method for exploring so as to recursively improve the tally images and confidential image in image quality and therefore has a problem such that a huge calculation cost is required.

Thus, the conventional tally image generating methods that are high in entertainment ability and allow embedding a multitone gray-scale confidential image result in either a poor image quality or a huge calculation cost of tally images, and no tally image generating method that satisfies both requirements exists.

### SUMMARY OF THE INVENTION

It is an object of the present invention to solve the problems described above and provide a speedy high-quality tally image generating method and device focusing on expressiveness of a confidential image at the time of decoding, a tally image generating program, and a confidential-image decoding method that can speedily generate high-quality tally images in which a continuous multitone gray-scale confidential image such as a natural image is embedded, without spending a huge calculation cost and can make the respective tally images not be completely or practically recognized although the gray-scale confidential image can be satisfactorily perceived from a decoded image for which a decoding operation has been carried out for a plurality of tally images.

In order to accomplish the object, a aspect of the present invention is that a tally image generating method comprising a first step of generating a first tally image by applying a halftoning process to a first input original image; and a second step of generating a second tally image by an embedding process of a confidential image by using an error diffusion method by use of the first tally image generated by the first step, a confidential image, and a second input original image, wherein the second step is of calculating decoded pixel values of pixels around a currently processed pixel, calculating a peripheral luminance value around the currently processed pixel by use of the decoded pixel values, and determining a pixel value of the currently processed pixel of the second tally image taking the peripheral luminance value into consideration.

Here, the peripheral luminance value around a currently processed pixel can be calculated by use also of a pixel value of the currently processed pixel in the second tally image before the embedding process of a confidential image and a pixel value of the first tally image corresponding to a position of the currently processed pixel in the second tally image. In addition, processes in the first and second steps can be carried out after correcting luminance value ranges of the first and second input original images and confidential image.

The present invention can be realized also as a program that makes a computer realize functions to generate a first tally image and a second tally image. The present invention also includes a decoding method for decoding confidential image by irradiating a transmitting light onto transparent media on which the first and second tally images generated as in the above have been printed or by applying logical AND, OR, or XOR to each pixel of the first and second tally images.

According to the present invention, by generating tally images by extending an error diffusion method, high-quality tally images can be generated and tally images can be generated speedily at a low cost in comparison with a tally image generating method using an exploratory halftone image generating method. In addition, a continuous multitone gray-scale confidential image such as a natural image can be embedded, tally images that are very high in expressiveness of a decoded image can be generated.

In addition, since a pixel value of a currently processed pixel in the second tally image is determined while taking into consideration a peripheral luminance value around the currently processed pixel calculated based on decoded pixel values of pixels around the currently processed pixel or taking into consideration a peripheral luminance value around the currently processed pixel calculated, in addition thereto, by use also of a pixel value of the currently processed pixel in the second tally image before the embedding process of a confidential image and a pixel value of the first tally image corresponding to a position of the currently processed pixel in the second tally image, the confidential image can be decoded in a condition where the respective tally images cannot be completely or practically recognized.

Thereby, high-quality tally images can be generated while giving little stress of waiting on a user and a confidential image that is high in expressiveness can be decoded, therefore, a system high in entertainment ability can be realized.

### BRIEF DESCRIPTION OF THE DRAWINGS

FIG. 1 is a block diagram showing an embodiment of the first tally image generating means (binarizing means) of the present invention.

FIG. 2 is a block diagram showing an embodiment of the second tally image generating means (binarizing means) of the present invention.

FIG. 3 is a chart showing a concrete example of a matrix used in the peripheral luminance value calculating means of FIG. 2.

FIG. 4 is a flowchart showing operations of the confidential-image embedding means of FIG. 2.

FIG. 5 is a block diagram showing another embodiment of the second tally image generating means (binarizing means) of the present invention.

FIG. 6 are charts showing concrete examples of a matrix used in the peripheral luminance value calculating means of FIG. 5.

FIG. 7 is a block diagram showing an embodiment of a tally image generating device (a case involving luminance correction) according to the present invention.

FIG. 8 are graphs showing examples of luminance correction characteristics of the luminance correction means of FIG. 7.

FIG. 9 are views showing actual examples (256×256 pixels) of tally images generated and a confidential image decoded by the present invention.

FIG. 10 are views showing actual examples (400×400 pixels) of tally images generated and a confidential image decoded by the present invention.

FIG. 11 are views showing other actual examples of tally images generated by the present invention and a confidential image decoded by superposing these.

FIG. 12 are views showing other actual examples of tally images generated by the present invention and a confidential image decoded by superposing these.

FIG. 13 is a conceptual diagram showing a composition for decoding a confidential image from tally images.

FIG. 14 is a conceptual diagram showing a composition of conventional tally image generation.

FIG. 15 is a conceptual diagram showing another composition of conventional tally image generation.

FIG. 16 is a block diagram showing an embodiment of the first tally image generating means of FIG. 15.

FIG. 17 is a block diagram showing an embodiment of the second tally image generating means of FIG. 15.

FIG. 18 is a chart showing a concrete example of a matrix used in the error calculating means of FIG. 16.

FIG. 19 is a flowchart showing operations of the confidential-image embedding means of FIG. 17.

### DETAILED DESCRIPTION OF THE PREFERRED EMBODIMENTS

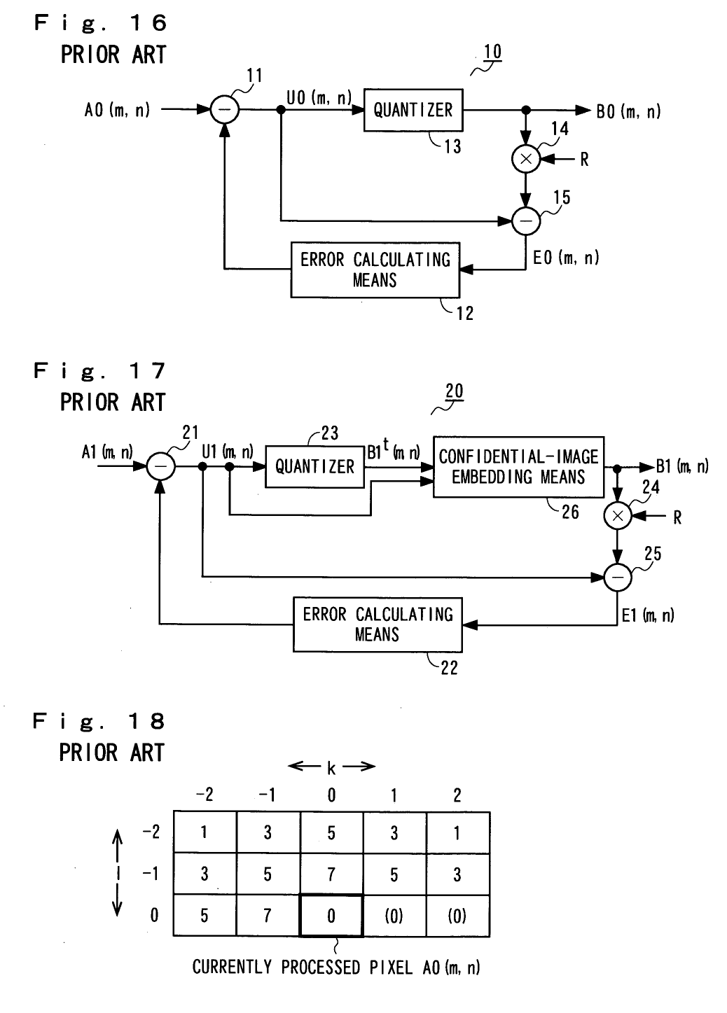

First, a conventional tally image generating device using an error diffusion method will be described. The conventional tally image generating device using an error diffusion method has a basic configuration shown in FIG. 15, and first and second tally image generating means 10 and 20 have configurations shown in FIG. 16 and FIG. 17, respectively. Such a tally image generating device has been described in Non-Patent Literature 4.

First, a first tally image B0 is generated from an original image A0 by the configuration of FIG. 16. This is the same as halftone image generation by a normal error diffusion method. Here, the original image A0 is first inputted to a subtracter 11. A pixel A0m,n at an XY coordinate position (m,n) in the original image A0 has, for example, 256-gray-scale values between 0 (black) and 1 (white). To the subtracter 11, an error (1/H)×Σ(Hk,1×E0m+k,n+1) accumulated so far, which is simultaneously outputted from an error calculating means 12, is inputted. The subtracter 11 calculates an original-image luminance value U0m,n=A0m,n−(1/H)×Σ(Hk,1×E0m+k,n+1) that takes the accumulated error into consideration.

Here, (k,1) indicates a coordinate value taking the position of a currently processed pixel A0m,n as (0,0). Hk,1 indicates a matrix used by an error diffusion method, and H indicates a value obtained by adding up weighting factors. In addition, E0m+k,n+1 indicates an error at a pixel (k,1) around the pixel A0m,n. (1/H)×Σ(Hk,1×E0m+k,n+1) means an accumulated error calculated by weighting with regard to the pixels around the pixel A0m,n.

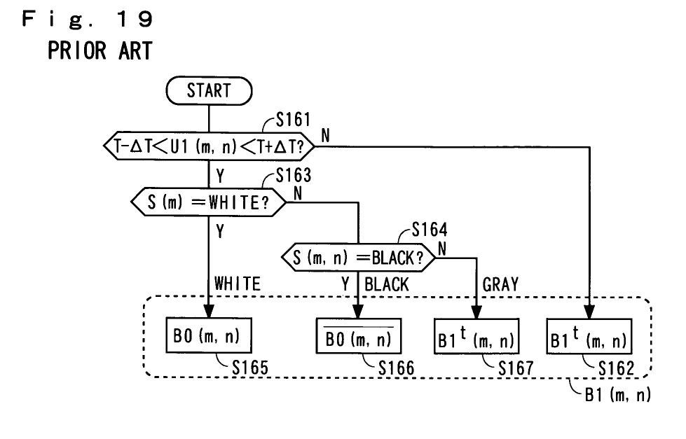

A concrete example of the matrix nk,1 is shown in FIG. 18. This is called a Jarvis, Judice and Ninke filter. However, errors at pixels after the pixel A0m,n in terms of time are not added since these have not yet been obtained (in FIG. 18, the weighting factors are indicated by (0)).

Next, a quantizer 13 applies quantization to the original-image luminance value U0m,n that takes the accumulated error into consideration so as to output a binary pixel value B0m,n. For the quantization herein applied, a calculation is carried out with, for example, T=0.5, and if (U0m,n>T), then B0m,n=1 or else B0m,n=0.

The binary pixel value B0m,n outputted from the quantizer 13 is sent out as a pixel value of the first tally image B0 and inputted to a subtracter 15 via a multiplier 14. Since a multiplier factor R in the multiplier 14 can be provided as 1.0, description of R will be omitted in the following. R can be omitted since an input original-image luminance value range is provided this time as 0 to 1.0, however, R=255 is multiplied when the input original-image luminance value range is 0 to 255.

To the subtracter 15, the original-image luminance value U0m,n that takes the accumulated error into consideration is simultaneously inputted from the subtracter 11. The subtracter 15 determines an error E0m,n=B0m,n-U0m,n between the binary pixel value B-m,n determined by the quantizer 13 and original-image luminance value U0m,n that takes the accumulated error into consideration and inputs the error to an error calculating means 12.

The error calculating means 12 calculates (1/H)×Σ(Hk,1×E0m+k,n+1) by weighting errors at the pixels around the pixel A0m,n with the weighting matrix Hk,1 and summing up the products so as to calculate Σ(Hk,1×E0m+k,n+1) and further by dividing the same by the value H obtained by adding up weighting factors of the matrix Hk,1.

Next, by use of the tally image B0 generated in FIG. 16, and an original image A1, and a ternary confidential image S, a second tally image B1 is generated by the configuration shown in FIG. 17 by using an error diffusion method. FIG. 17 is different from FIG. 16 in that a confidential-image embedding means 26 is provided after quantization and embedding of the confidential image S is herein carried out. The confidential-image embedding means 26 is sometimes referred to as a noise generator since this generates noise in terms of the image quality of the tally image B1.

In FIG. 17, the original image A1 is inputted to a subtracter 21. A pixel A0m,n at a position (m,n) in the original image A1 also has 256-gray-scale values between 0 (black) and 1 (white). The subtracter 21 calculates an original-image luminance value U1m,n=A1m,n−(1/H)×Σ(Hk,1×E1m+k,n+1) that takes an accumulated error into consideration. A quantizer 23 applies quantization to the original-image luminance value U0m,n that takes an accumulated error into consideration so as to output a binary pixel value B1^{t}m,n. The binary pixel value B1^{t}m,n is 0 (black) or 1 (white), which is a pixel value temporarily determined for a currently processed pixel in the second tally image B1 before being embedded with the confidential image S.

The temporarily determined pixel value B1^{t}m,n is an output value that allows generating a high-quality tally although this can be changed thereafter as a result of the confidential image S being embedded in the confidential-image embedding means 26.

The temporarily determined pixel value B1^{t}m,n is inputted to the confidential-image embedding means 26. The confidential-image embedding means 26 is also inputted with a luminance value Sm,n of the confidential image S and a pixel value B0m,n of the first tally image B0. The confidential-image embedding means 26 calculates a pixel value B1m,n of the second tally image B1 embedded with the confidential image S by use of the temporarily determined pixel value B1^{t}m,n, luminance value. Sm,n of the confidential image S, and pixel value B0m,n of the first tally image B0.

A binary pixel value B1m,n outputted from the confidential-image embedding means 26 is sent out as the pixel value B1m,n of the second tally image B1 and is inputted to a subtracter 25 via a multiplier 24. Description of the multiplier 24, subtracter 25, and an error calculating means 22 will be omitted since these carry out the same processings as those of the multiplier 14, subtracter 15, and error calculating means 12 of FIG. 16.

FIG. 19 is a flowchart showing operations of the confidential-image embedding means 26, whereby the second tally image B1 is generated.

In FIG. 19, it is first judged as to whether or not the original-image luminance value U1m,n that takes an accumulated error into consideration is a value between T−ΔT and T+ΔT (S161). Here, as T and ΔT, values such as, for example, T=0.5 and ΔT=0.05 can be used when it is judged in S161 that the original-image luminance value U1m,n that takes an accumulated error into consideration is not a value between T−ΔT and T+ΔT, the temporarily determined pixel value B1^{t}m,n is outputted as the pixel value B1m,n of the second tally image B1 as it is (S162). This is for preventing the image quality from being considerably deteriorated.

In addition, when it is judged that the original-image luminance value U1m,n that takes an accumulated error into consideration is a value between T−ΔT and T+ΔT, it is subsequently judged as to whether the luminance value Sm,n of the confidential image S is 1 (white) or 0 (black) or is 0.5 (gray) (S163, S164), and the temporarily determined pixel value B1^{t}m,n is changed according to a result of the judgment.

When it is judged in S163 that the luminance value Sm,n of the confidential image S is 1 (white), the pixel value B0m,n of the first tally image B0 is outputted as the image value B1m,n of the second tally image B1 as it is (S165). In addition, when it is judged in S164 that the luminance value Sm,n of the confidential image S is 0 (black), the pixel value B0m,n of the first tally image B0 is inverted and outputted (S166), and when judged not to be so, namely, judged to be 0.5 (gray), the temporarily determined pixel value B1^{t}m,n is outputted (S167). The inversion means to change a black pixel to a white pixel, and a white pixel, to a black pixel.

In the conventional tally image generating device using an error diffusion method, when the original-image luminance value U1m,n that takes an accumulated error into consideration is within a variation ΔT of a threshold value T, a desired pixel value B1m, n can be outputted for the second tally image B1. In addition, as is apparent from the flowchart of FIG. 19, when the luminance value Sm,n of the confidential image S is 0 (black), the pixel value B0m,n of the first tally image B0 is inverted and is outputted as the pixel value B1m,n of the second tally image B1, and when 1 (white), the same pixel value as the pixel value B0m,n of the first tally image B0 is outputted as the pixel value B1m,n of the second tally image B1, and when 0.5 (gray), the pixel value B1m, n of the second tally image B1 is determined regardless of the pixel value B0m,n of the first tally image B0.

However, the pixel B1m,n of the second tally image B1 is determined based on the condition of the luminance value Sm,n of the confidential image S, and when this is determined, luminance information of peripheral pixels for which pixel values have already been determined is not taken into consideration. Therefore, a correlation between pixel values of the confidential image S cannot be maintained on a decoded image, so that roughness of the confidential image may occur on the decoded image or characteristics of the tally images B0 and B1 may be produced on the decoded image.

The present invention has been made to generate tally images while further expanding tally image generation using an error diffusion method as described above so that a satisfactory decoded image can be obtained, and hereinafter, embodiments thereof will be described. In the following, description will be given for a case where the present invention is realized as a tally image generating device, however, the present invention can be realized also as a tally image generating method and a computer program for generating tally images.

A tally image generating device according to the present invention has, similar to the conventional device, the basic configuration shown in FIG. 15 and includes a first tally image generating means 10 and a second tally image generating means 20, however, it is different in the second tally image generating means 22, and can satisfactorily embed a continuous multitone gray-scale confidential image.

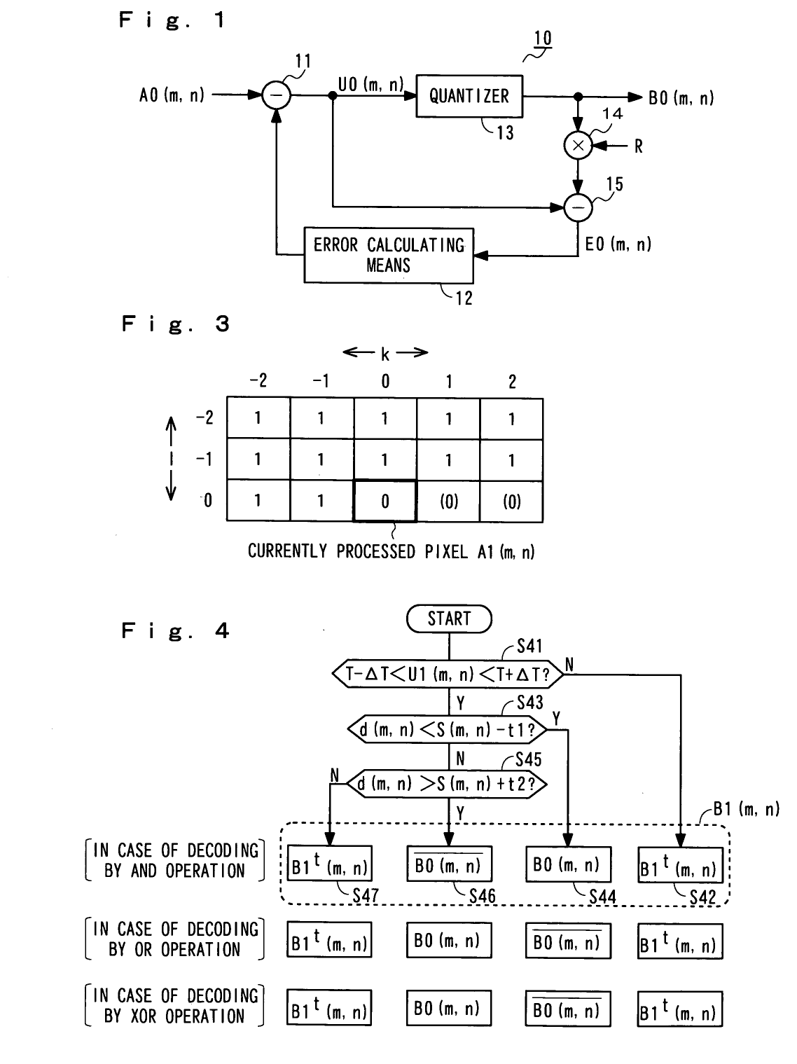

FIG. 1 is a block diagram showing a configuration example of the first tally image generating means 10, description of which will be omitted since this is the same as FIG. 16. In this connection, the first tally image generating means 10 can employ any binarizing method without limitation to the error diffusion method.

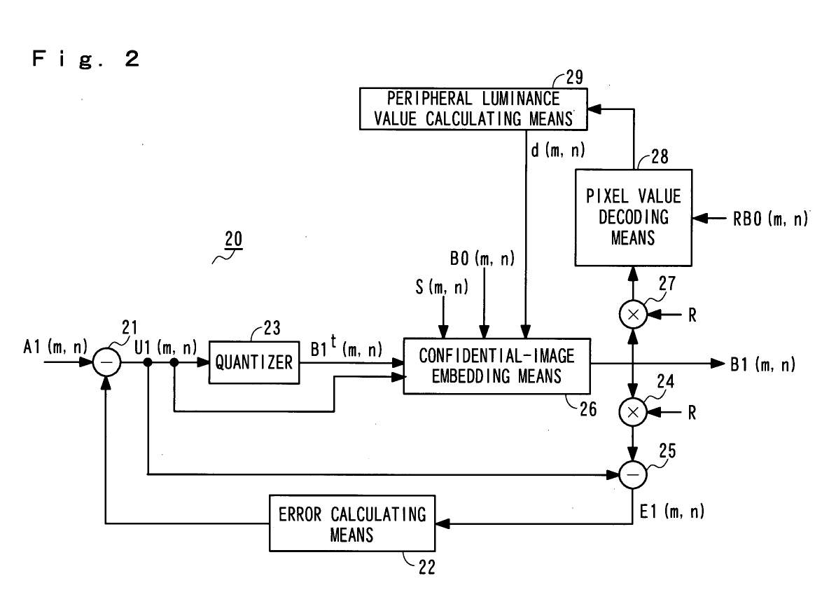

FIG. 2 is a block diagram showing an embodiment of the second tally image generating means 20. In the present embodiment, the second tally image generating means 20 includes, in addition to the components of the conventional second tally image generating means, a peripheral luminance value calculating section composed of a decoded pixel value calculating means 28 and a peripheral luminance value calculating means 29, and a confidential-image embedding means 26 calculates a pixel value B1m,n of a second tally image B1 by use of a temporarily determined pixel value B1^{t}m,n, a luminance value Sm,n of a confidential image S, and a pixel value B0m,n of a first tally image B0 and furthermore, a peripheral luminance value dm,n calculated by the peripheral luminance value calculating means 29. Other aspects of the configuration and operations are the same as those of FIG. 17.

The decoded pixel value calculating means 28 applies Boolean operations to the pixel value B0m,n of a first tally image B0 from a quantizer 13 (FIG. 1) and the pixel value B1m,n of the second tally image B1 from the confidential-image embedding means 26 so as to calculate a pixel value Vm,n=B0m,n⊚B1m,n at the time of decoding. In this connection, ⊚ indicates Boolean operation such as AND, OR, or XOR. When the pixel value B1m,n of the second tally image B1 is determined, the pixel value B0m,n of the first tally image B0 has already been determined, so that these operations are possible.

The peripheral luminance value calculating means 29 calculates a peripheral luminance value dm,n at the time of decoding by expression (1) by multiplying decoded pixel values Vm+k,n+1 of pixels around an already-determined currently processed pixel A1m,n by a matrix Mk,1 and summing up the products and further by dividing the same by a value M obtained by adding up weighting factors of the matrix Mk,1.
dm,n=(1/M)×Σ(Vm+k,n+1×Mk,1) (1)

A concrete example of the matrix Mk,1 is shown in FIG. 3. In the present concrete example, the weighting factors to the pixels around the pixel A1m,n are all provided as 1. The matrix Mk,1 is provided here in a size of 3 by 5 pixels, however, this can be provided in any size greater or smaller than the same.

By expression (1) described above, a decoding-time luminance value around the pixel A1m,n in process can be obtained. In a case of pixels at an edge part and the like of an image, some of the pixels to which the matrix Mk,1 refers sometimes do not exist, however, it is sufficient in such a case to carry out operations only within a range where the pixels to which the matrix Mk,1 refers exist. Moreover, when the value M obtained by adding up weighting factors of the matrix Mk,1 is equal to 0 or when the pixels to which the matrix Mk,1 refers do not exist at all, it is sufficient to set an arbitrary value so as not to cause a program error or to output the temporarily determined pixel value B1^{t}m,n as it is without embedding a confidential image.

In addition, irrespective of whether or not it is an edge part of an image, the peripheral luminance value dm,n can be calculated with the value M obtained by adding up weighting factors of the matrix Mk,1 fixed. As the matrix Mk,1, a flat matrix where all weighting factors have 1 or a matrix having a greater matrix as it is closer to the pixel A1m,n can be used.

It is also possible to align the center of a two-dimensional Gaussian filter with the pixel A1m,n, and multiply, in both two tallies, only a decoded pixel value Vm−k,n−1 of a part where the pixel value has been determined by a weighting factor (filter factor) and add up the products.

When the matrix where the weighting factor is greater as it is closer to the pixel A1m,n is used, a confidential image to be decoded easily forms a contrast in comparison with when the flat matrix is used, however, consideration to the peripheral luminance is reduced.

FIG. 4 is a flowchart showing operations of the confidential-image embedding means 26, according to which the second tally image B1 is generated. In FIG. 4, in addition to the pixel values outputted by the confidential-image embedding means 26 in a case of decoding by an AND operation, the pixel values outputted in cases of decoding by an OR operation and an XOR operation are also shown, however, description will be given of the operations in a case of decoding by an AND operation.

In the confidential-image embedding means 26, it is first judged as to whether or not the original-image luminance value U1m,n that takes an accumulated error into consideration is a value between T−ΔT and T+ΔT (S41). Here, as T and ΔT, values such as, for example, T=0.5 and ΔT=0.05 can be used.

When it is judged in S41 that the original-image luminance value U1m,n that takes an accumulated error into consideration is not a value between T−ΔT and T+ΔT, the temporarily determined pixel value B1^{t}m,n is outputted as the pixel value B1m,n of the second tally image B1 as it is (S42).

In addition, when it is judged that the original-image luminance value U1m,n that takes an accumulated error into consideration is a value between T−ΔT and T+ΔT, the peripheral luminance value dm,n is compared with the luminance value Sm,n of the confidential image S, and the pixel value B1m,n of the second tally image B1 is determined according to a result of the comparison.

For example, t1 and t2 are respectively provided as predetermined threshold values, and whether or not dm,n<Sm,n−t1 is judged (S43). When it is judged in S43 that dm,n<Sm,n−t1, it is considered that the peripheral luminance value dm,n tends to be low, a pixel value B0m,n that is the same as the pixel value B0m,n of the first tally image B0 is outputted as the pixel value B1m,n of the second tally image B1 (S44).

On the other hand, when it is not judged in S43 that dm,n<Sm,n−t1, it is further judged as to whether or not dm,n>Sm,n+t2 (S45). When it is judged in S45 that dm,n>Sm,n+t2, since it is considered that the peripheral luminance value tends to be high, the pixel value B0m,n of the first tally image B0 is inverted and outputted as the pixel value B1m,n of the second tally image B1 (S46). When it is not judged in S45 that dm,n>Sm,n+t2, since it is considered that the peripheral luminance value dm,n is nearly accurate, the temporarily determined pixel value B1^{t}m,n is outputted as the pixel value B1m,n of the second tally image B1. It is desirable that t1 and t2 are set within a range of approximately 0 to 0.1.

Setting of t1 and t2 will be described in the following. As described above, t1 and t2 are threshold values to judge that the peripheral luminance value dm,n (estimated superposition density) after embedding is “too dark,” “too bright,” or “neither of these” in comparison with the luminance value Sm,n of the confidential image S, and by setting these threshold values appropriately, dm,n can be approximated Sm,n as close as possible so that a superposed image is clearly produced.

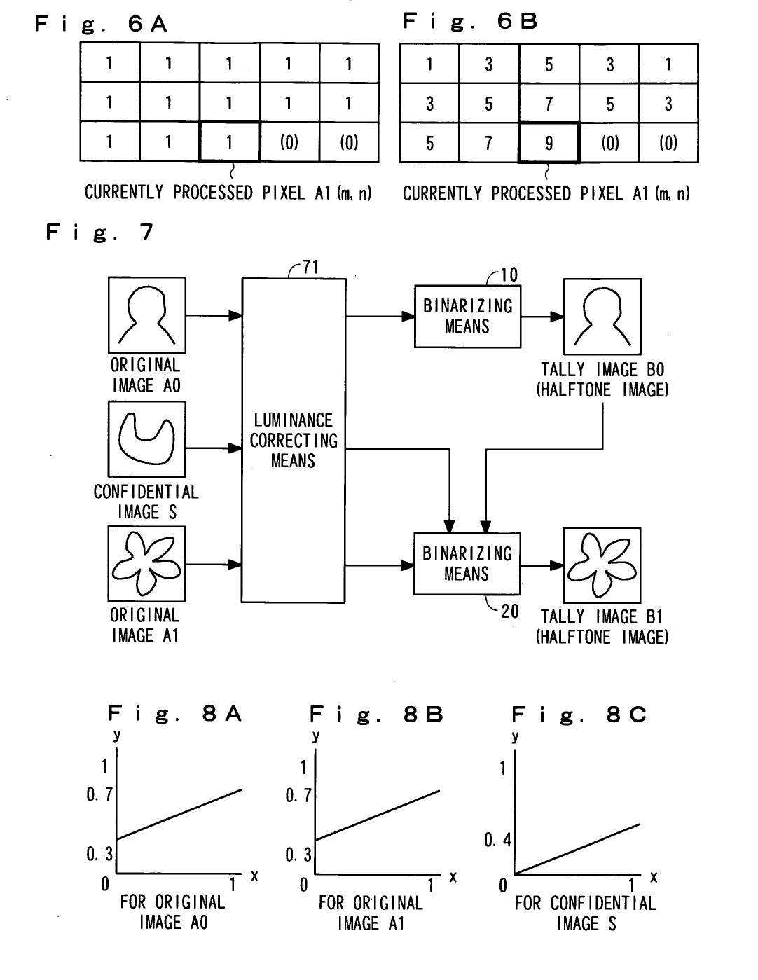

When dm,n is “too dark” in comparison with Sm,n, B1m,n=B0m,n is embedded in order to brighten this. In this case, as a result, the temporarily determined pixel value B1^{t}m,n and the pixel value to be outputted can be different and can be the same. When dm,n varies after B1^{t}m,n is inverted, it is desirable to set t1 at that time to t1=Δd/2 so that dm,n approximates Sm,n. Here, Δd=Ak,1/ΣAm+k,n+1, where Ak,1 is a filter factor corresponding to a currently processed pixel, and ΣAm+k,n+1 is a sum total of filter factors. As the filter, for example, a Gaussian filter or a filter whose filter factor corresponding to a currently processed pixel is not 0 as shown in FIG. 6 is used, Δd, which is an absolute value of a variation in the superposition density before and after inversion of B1^{t}m,n, takes a constant determined by filter factors. Moreover, a dynamic range of white and black is provided as “1.” By setting t1 as such, the superposition density is easily approximated to the luminance value of the confidential image.

In addition, when the superposition density does not vary after B1^{t}m,n is inverted, it is preferable to set t1 at that time to t1<Δd/2. For example, when t1=Δd/4 is set, a superposed image is more clearly produced.

In a case where the superposition density is “too bright” in comparison with Sm,n, as well, when dm,n varies after B1^{t}m,n is inverted, it is desirable to set t1=Δd/2, and when the superposition density does not vary after B1^{t}m,n is inverted, it is preferable to set t2<Δd/2, for example, t2=Δd/4.

When dm,n is “neither of these” in comparison with Sm,n, the pixel value B1^{t}m,n is outputted as B1m,n so that the superposition density easily approximates the luminance value of the confidential image.

In the present invention, since the peripheral luminance value calculating means 29 is provided so as to calculate the luminance value dm,n around the currently processed pixel at the time of decoding and the pixel B1m,n of the second tally image B1 is determined with said peripheral luminance value dm,n taken into consideration, a correlation between pixel values of the confidential image S can be maintained on a decoded image, so that roughness of the confidential image is suppressed from occurring on the decoded image or characteristics of the tally images B0 and B1 are suppressed from being produced on the decoded image.

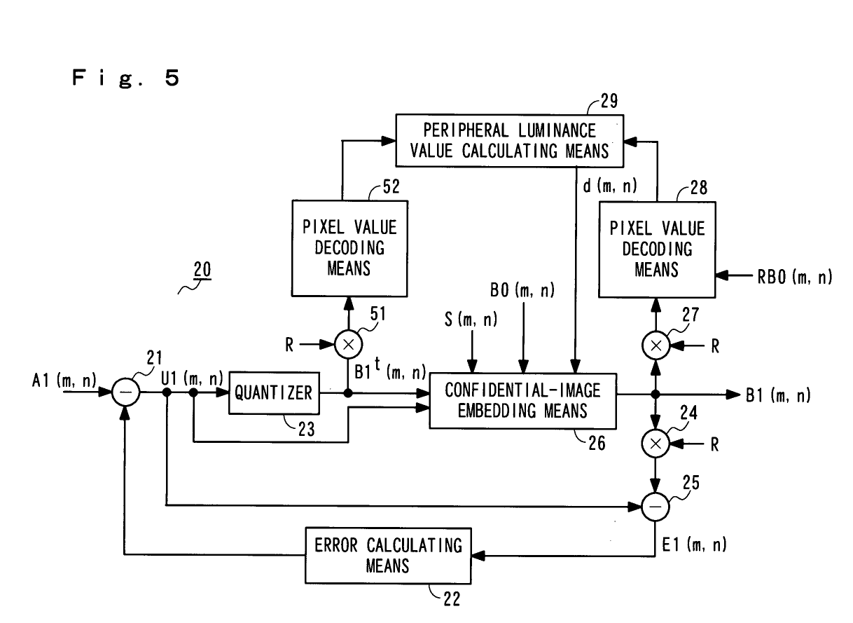

FIG. 5 is a block diagram showing another embodiment of the second tally image generating means 20, in which identical reference numerals are used for parts identical or equivalent to those of FIG. 2. In the present embodiment, the second tally image generating means 20 includes a multiplier 51 and a decoded pixel value calculating means 52 that decodes a temporarily determined pixel value B1^{t}m,n of the pixel A1m,n, and the temporarily determined pixel value B1^{t}m,n is also reflected in a peripheral luminance value dm,n.

The decoded pixel value calculating means 52 applies an AND operation to the temporarily determined pixel value B1^{t}m,n and a pixel value B0m,n of a first tally image B0 so as to calculate a pixel value V1m,n at the time of decoding of the temporarily determined pixel value B1^{t}m,n.

The peripheral luminance value calculating means 29 calculates a peripheral luminance value dm,n in which the temporarily determined pixel value B1^{t}m,n of the pixel A1m,n has been reflected by expression (2) by multiplying decoded pixel values Vm−k,n−1 of pixels around the pixel A1m,n and the pixel value Vm,n obtained by decoding the temporarily determined pixel value B1^{t}m,n by a matrix Mk,1 and summing up the products and further by dividing the same by a value M obtained by adding up weighting factors of the matrix Mk,1.
dm,n=(1/M)×Σ(Vm+k,n+1×Mk,1) (2)

Although expression (2) is the same as expression (1), the matrix Mk,1 used here is different from that of FIG. 3, and for example, as shown in FIG. GA or 6D, the weighting factor to the pixel A1m,n has a predetermined value. FIG. 6A is a flat matrix where all weighting factors are 1, FIG. 6B is a matrix where the weighting factor is greater as it is closer to the pixel A1m,n, and either matrix can be used here.

It has been provided in the above description that the original images A1 and A2 and confidential image S are inputted as they are to the first or second tally image generating means 10 or 20, however, by correcting those images in luminance before a binarization process in the first or second tally image generating means 10 or 20, a decoded confidential image can be enhanced in visibility.

FIG. 7 is a block diagram showing an embodiment of a tally image generating device involving the luminance correction. In the present embodiment, first, original images A0 and A1 and a confidential image S are corrected in luminance by a luminance correcting means 71.

A first tally image generating means 10 generates a first tally image B0 based on the luminance-corrected original image A0, while a second tally image generating means 20 generates a second tally image B1 based on the first tally image B0, luminance-corrected confidential image S, and luminance-corrected original image A1.

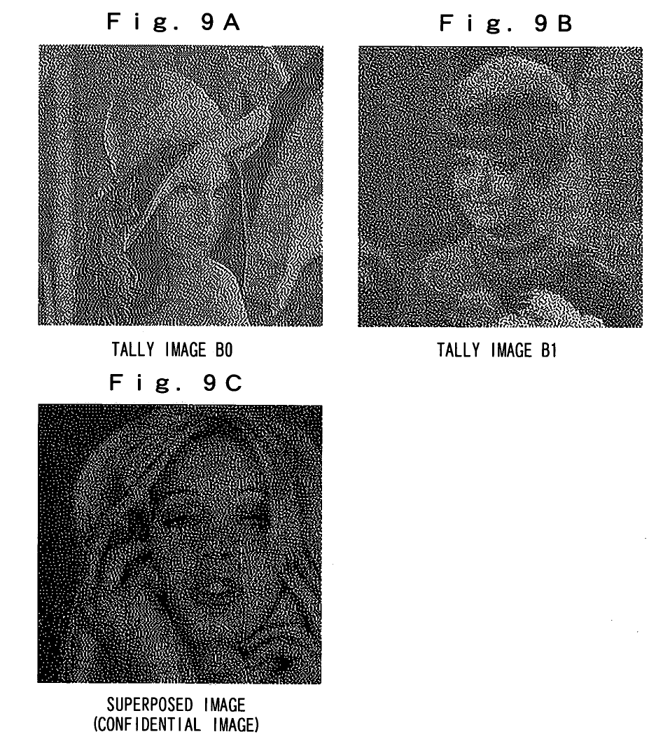

FIG. 8 are graphs showing examples of luminance correction characteristics in the luminance correcting means 71. When the confidential image S is decoded by an AND operation, it is preferable to apply a luminance correction to the original images A0 and A1 so that luminance values concentrate in middle luminance value range and apply a luminance correction to the confidential image S so that luminance values concentrate in low luminance value range.

Where 0 is black and 1 is white, for example, as shown in FIGS. 8A and 8B, a luminance value transformation is applied to the original images A0 and A1 so that the luminance value is within 0.3 to 0.7, and to the confidential image S, as shown in FIG. 8C, a luminance value transformation is applied so that the luminance value is within 0.0 to 0.4. The luminance correction characteristics to the original images A0 and A1 do not necessarily have to be identical. In addition, depending on luminance value distributions of the original images A0 and A1 and confidential image S, it is sufficient to apply a luminance correction to one of two of these images.

In a case of a luminance correction by a linear transformation, where x on an XY coordinate is a luminance value of an input original image and y is a luminance value after a luminance transformation, in FIG. 8A and 8B, the luminance value y after a transformation can be calculated based on the luminance value x of the original images A1 and A2 according to a transformation formula of y=0.4x+0.3. In FIG. 8C, it can be calculated according to a transformation formula of y=0.4x. The transformation formula can be the same or different for the original images A1 and A2. Generally, two points on the XY coordinate are designated, and the luminance value can be transformed by use of a formula that expresses a straight line passing through these points. Without limitation through the linear transformation, it is also possible to carry out a luminance conversion by a non-linear transformation.

Generally, the more concentrated are the luminance values of the original images A0 and A1 to middle luminance value range, the wider the range of a luminance value that the confidential image S can express can be made, so that a confidential image at the time of decoding can be improved in visibility. In addition, by flattening a luminance value histogram of the confidential image S before carrying out a luminance transformation thereof, the confidential image S can be enhanced in contrast.

For a tally when the confidential image S is decoded by an OR operation, it is sufficient to carry out a luminance correction so that the confidential image S concentrates at high luminance values, and for a tally when the confidential image S is decoded by an XOR operation, it is sufficient to carry out a luminance correction so that the confidential image S concentrates in low luminance value range.

When the present invention is realized as a computer program, it is sufficient to include, in the program, a first function of applying a halftoning process to a first input original image so as to generate a first tally image and a second function of generating a second tally image by an embedding process of a confidential image using the first tally image generated by the first function, a confidential image, and a second input original image, and at this time, calculating decoded pixel values of pixels around a currently processed image, calculating a peripheral luminance value around the currently processed pixel based on said decoded pixel values, and determining a pixel value of the currently processed pixel of the second tally image taking said peripheral luminance value into consideration.

In addition, by printing the first and second tally images generated as in the above on transparent media, respectively, and irradiating a transmitting light while superposing these or by executing an operation to determine a logical AND, OR, or XOR of each pixel of the first and second tally images, the confidential image can be decoded.

FIG. 9 are views showing actual examples of tally images B0 and B1 (256×256 pixels) generated by the present invention and a confidential image (256×256 pixels) decoded by superposing (AND operation) these. Here, where black was 0 and white was 1, the luminance value ranges of the original images A0 and A1 provided for generation of the tally images B0 and B1 were corrected to 0.3 to 0.7 and 0.3 to 0.75, respectively, and the luminance value range of the confidential image S was corrected to 0 to 0.5. Moreover, in the peripheral luminance value calculating means 29, a histogram of the confidential image S was flattened by use of the matrix of FIG. 6A.

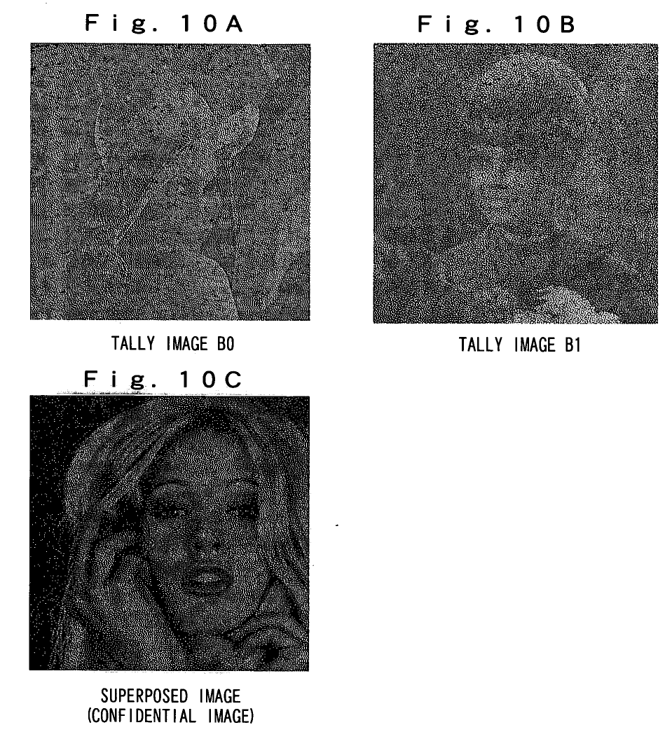

FIG. 10 are views showing actual examples of a tally image B0 (FIG. 10A), a tally image B1 (FIG. 10B), and a confidential image (FIG. 10C) decoded by superposing (AND operation) these when the number of pixels are increased to 400×400 pixels.

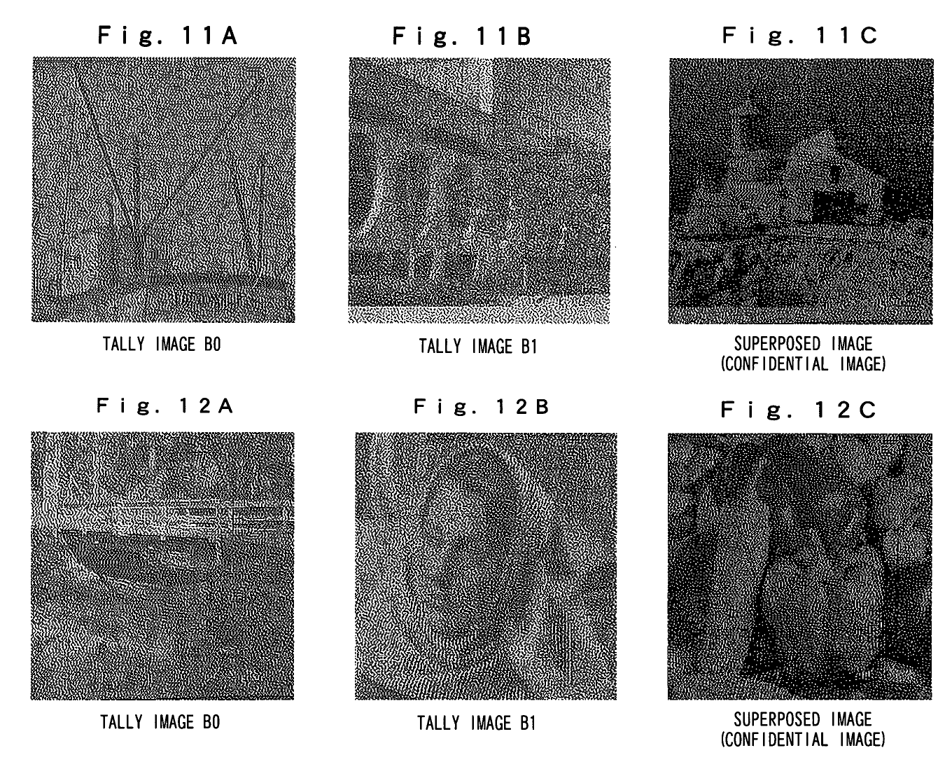

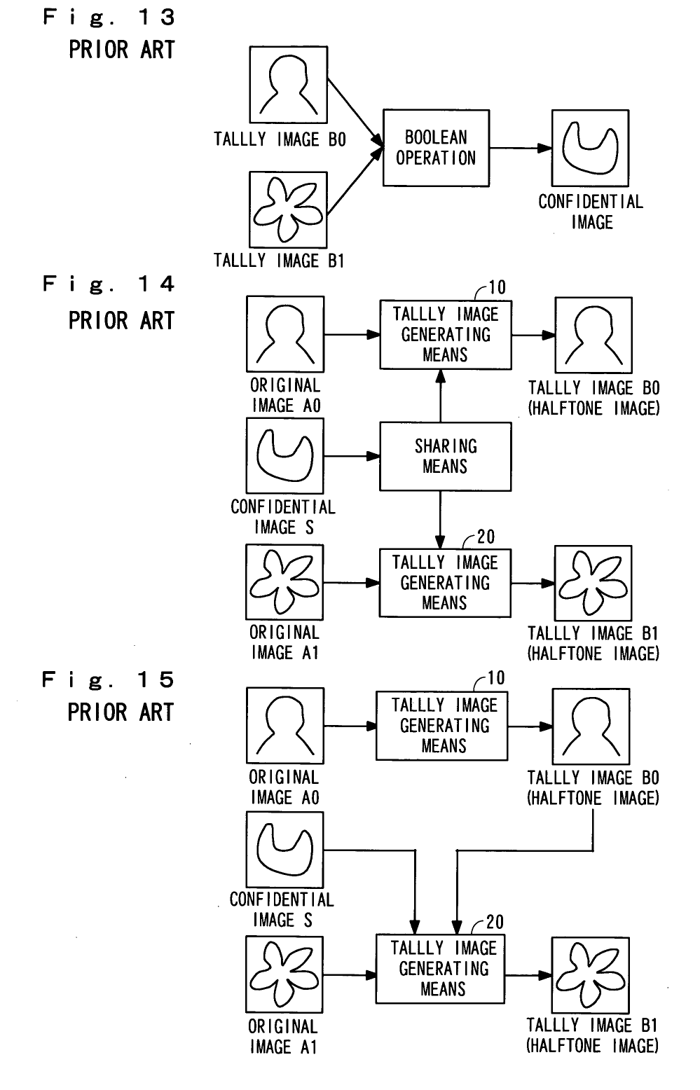

FIG. 11 and FIG. 12 are views showing actual examples of other tally images B0 and B1 and a confidential image decoded by superposing these. FIG. 11 show an example where an image of a ship (FIG. 11A) and an image of a building (FIG. 11B) are superposed to decode an image of a building by the sea (FIG. 11C), and FIG. 12 show an example where an image of a bridge (FIG. 12A) and an image of a woman (FIG. 12B) are superposed to decode an image of green peppers (FIG. 12C), wherein tones are expressed in detail.

1. A tally image generating method comprising:
a first step of generating a first tally image by applying a halftoning process to a first input original image; and
a second step of generating a second tally image by embedding a confidential image by using an error diffusion method by use of the first tally image generated by the first step, a confidential image, and a second input original image, wherein
the second step is of decoding pixel values of pixels around a currently processed pixel in the second tally image, calculating a peripheral luminance value around the currently processed pixel by use of the decoded pixel values, and determining a pixel value of the currently processed pixel of the second tally image taking the peripheral luminance value into consideration.

2. The tally image generating method according to claim 1, wherein
the second step is of calculating the peripheral luminance value around the currently processed pixel by use also of a pixel value of the currently processed pixel in the second tally image before being embedded with a confidential image.

3. The tally image generating method according to claim 1,
wherein the second step is of calculating the peripheral luminance value by weighting each pixel value.

4. The tally image generating method according to claim 1,
wherein the second step is of determining the pixel value of the currently processed pixel according to a result of comparison between the peripheral luminance value around the currently processed pixel and a luminance value of the confidential image.

5. The tally image generating method according to claim 4,
wherein in the comparison between the peripheral luminance value around the currently processed pixel and the luminance value of the confidential image, a threshold value to a difference between both is set so that the peripheral luminance value around the currently processed pixel approximates the luminance value of the confidential image so that a superposed image of the first tally image and the second tally image is clearly produced.

6. The tally image generating method according to claim 1,
wherein the decoded pixel values of pixels around the currently processed pixel are stored in a memory.

7. The tally image generating method according to claim 1, wherein the process for determining the pixel value of the currently processed pixel is repeatedly carried out for each pixel.

8. The tally image generating method according to claim 1,
wherein a luminance value range of at least one of the first and second input original images and confidential image is corrected before processing the images in the first and second steps.

9. The tally image generating method according to claim 8,
wherein for correction of the luminance value range, a luminance transformation is carried out so as to concentrate the first and second input original images in a middle luminance value range and concentrate the confidential image in a low-luminance value range or a high-luminance value range.

10. A tally image generating device comprising:
a first tally image generating means that generates a first tally image by applying a halftoning process to a first input original image; and
a second tally image generating means that generates a second tally image by an embedding a confidential image by using an error diffusion method by use of the first tally image generated by the first tally image generating means, a confidential image, and a second input original image, wherein
the second tally image generating means comprises a pixel value decoding means that decodes pixel values of pixels around a currently processed pixel in the second tally image, a peripheral luminance value calculating means that calculates a peripheral luminance value around the currently processed pixel based on the pixel values decoded by the pixel value decoding means, and a confidential-image embedding means that determines a pixel value of the currently processed pixel of the second tally image taking the peripheral luminance value calculated by the peripheral luminance value calculating means into consideration.

11. The tally image generating device according to claim 10, wherein the second tally image generating means further comprises a currently processed pixel value decoding means that decodes a pixel value of a currently processed pixel in the second tally image before being embedded with a confidential image, and the peripheral luminance value calculating means calculates the peripheral luminance value around the currently processed pixel by use also of a pixel value of the currently processed pixel decoded by the pixel value decoding means.

12. The tally image generating device according to claim 10, comprising a luminance correcting means that corrects a luminance value range of at least one of the first and second input original images and confidential image before inputting these to the first and second tally image generating means.

13. A program for making a computer realize the following programs:
a first function of generating a first tally image by applying a halftoning process to a first input original image; and
a second function of generating a second tally image by an embedding a confidential image by using an error diffusion method by use of the first tally image generated by the first function, a confidential image, and a second input original image, and at this time, decoding pixel values of pixels around a currently processed pixel, calculating a peripheral luminance value around the currently processed pixel based on the decoded pixel values, and determines a pixel value of the currently processed pixel of the second tally image taking the peripheral luminance value into consideration.

14. A confidential image decoding method for decoding a confidential image by irradiating a transmitting light onto transparent media on which the first and second tally images generated by any of claims 1, 10, or 13 have been respectively printed or by executing an operation to determine logical AND, OR, or XOR of each pixel of the first and second tally images generated by any of claims 1, 10, or 13.
